(19) United States
(12) Patent Application Publication
(10) Pub. No.: US 2025/0210910 A1
(43) Pub. Date: Jun. 26, 2025

(54) HEADPHONE AUDIO CABLE CONNECTION STRUCTURE

(71) Applicant: HEYUAN YUANFENG ELECTRONICS CO., LTD., Heyuan (CN)

(72) Inventors: Clive HUI, Heyuan (CN); Xixiang LIU, Heyuan (CN); Jingtao LAI, Heyuan (CN)

(73) Assignee: HEYUAN YUANFENG ELECTRONICS CO., LTD., Heyuan (CN)

(21) Appl. No.: 18/750,926

(22) Filed: Jun. 21, 2024

(30) Foreign Application Priority Data
Dec. 21, 2023 (CN) 2023235010588

(51) Int. Cl. H01R 13/625; H01R 13/629

(52) U.S. Cl. CPC H01R 13/625; H01R 13/629

(57) ABSTRACT

Disclosed is a headphone audio cable connection structure, including a headphone body and an audio cable, where the headphone body is provided with an audio cable insertion hole and a clamping sleeve, the audio cable extends into the clamping sleeve and is inserted into the audio cable insertion hole, inserting grooves and clamping grooves are formed on a side wall of the clamping sleeve, the audio cable is sleeved with a clamping seat, and protruding clamping blocks are arranged on the clamping seat. The present disclosure ensures a stable connection of the audio cable, prevents the audio cable from falling off, and facilitates replacement of the audio cable.

### CROSS-REFERENCE TO RELATED APPLICATIONS

The application claims priority to Chinese patent application No. 2023235010588, filed on Dec. 21, 2023, the entire contents of which are incorporated herein by reference.

### TECHNICAL FIELD

The present disclosure relates to a headphone, and particularly relates to a headphone audio cable connection structure.

### BACKGROUND

A headphone can be used as part of a communication system. Headphones facilitate users' communication in a hands-free mode through desktop computers, laptops, or mobile phones. The headphone enables a user to listen to audio without disturbing other users nearby. Headphones are divided into wired headphones or wireless headphones. The audio cable of a wired headphone is usually directly fixed inside the headphone, and the audio cable cannot be replaced, resulting in that once the audio cable is damaged, the entire headphone needs to be replaced, thereby increasing the cost of use. In order to allow for the replacement of the audio cable, the audio cable is directly inserted into the headphone, so that once the audio cable is obstructed by an object, the audio cable might be detached.

### SUMMARY

In order to solve the above technical problems, the present disclosure provides a headphone audio cable connection structure that ensures a more stable connection of the audio cable, prevents the audio cable from falling off, and is easy to operate.

In order to solve the above technical problems, the present disclosure adopts the following technical solution:
a headphone audio cable connection structure, including a headphone body and an audio cable, where the headphone body is provided with an audio cable insertion hole and a clamping sleeve, the audio cable extends into the clamping sleeve and is inserted into the audio cable insertion hole, and the audio cable is connected to the clamping sleeve in a buckled manner.

As a further improvement of the technical solution, inserting grooves and clamping grooves are formed on a side wall of the clamping sleeve, the inserting groove extends along an axis direction of the clamping sleeve, the clamping groove extends along a radial direction of the clamping sleeve, the clamping groove is communicated with the inserting groove, the audio cable is sleeved with a clamping seat, protruding clamping blocks are arranged on the clamping seat, and the protruding clamping block extends into the inserting groove and then the clamping seat rotates to move the protruding clamping block into the clamping groove, so that the clamping seat is securely fastened to the clamping sleeve.

As a further improvement of the technical solution, crack grooves are further formed on the clamping seat, and the crack groove is communicated with the clamping groove.

As a further improvement of the technical solution, the inserting groove and the clamping groove are distributed in a vertical direction, and the crack groove and the clamping groove are arranged in the same direction.

As a further improvement of the technical solution, the side wall of the clamping sleeve is symmetrically provided with two inserting grooves, two clamping grooves and two crack grooves, and the clamping seat is symmetrically provided with two protruding clamping blocks.

As a further improvement of the technical solution, the clamping groove is provided with a groove position, and a portion of the protruding clamping block extends into the groove position after the protruding clamping block moves into the clamping groove.

As a further improvement of the technical solution, the protruding clamping block is cylindrical.

As a further improvement of the technical solution, the protruding clamping blocks are integrally formed on the clamping seat.

As a further improvement of the technical solution, the side wall of the clamping seat is provided with anti-slip fringes.

Compared with the prior art, the present disclosure has the following beneficial effects:

The protruding clamping block arranged on the audio cable interlocks with the clamping groove on the headphone body, so that the audio cable is firmly connected to the headphone body and is not easily detached. Further, to remove the audio cable, it is only necessary to disengage the protruding clamping block from the clamping groove by rotating, which is convenient and efficient.

### BRIEF DESCRIPTION OF DRAWINGS

FIG. 1 is a schematic diagram of a three-dimensional structure of the present disclosure.

FIG. 2 is an enlarged view of a portion A in FIG. 1.

### REFERENCE NUMERALS IN FIGURES

headphone body 1, audio cable 2, clamping sleeve 3, inserting groove 4, clamping groove 5, clamping seat 6, protruding clamping block 7, crack groove 8, groove position 9, and anti-slip fringe 10.

### DETAILED DESCRIPTION OF THE EMBODIMENTS

Implementations of the present disclosure are described in detail below, examples of the implementations are shown in accompanying drawings, throughout which identical or similar reference numerals denote identical or similar elements or elements having identical or similar functions. The implementations described with reference to the accompanying drawings are exemplary and only intended to explain the present disclosure, instead of being construed as limiting the present disclosure.

In the description of the present disclosure, it should be understood that the related terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, and other indicated orientations or positional relationships are based on the orientations or positional relationships shown in the accompanying drawings, and are only for the convenience of describing the present disclosure and simplifying the description, rather than indicating or implying that indicated devices or elements must have a particular orientation, be constructed and operate in a particular orientation and are therefore not to be construed as limitations of the present disclosure. Furthermore, the terms “first” and “second” are merely for the purpose of description, and cannot be construed as indicating or implying relative importance or implicitly specifying the number of technical features indicated. Thus, a feature defined with “first” and “second” may explicitly or implicitly include one or more of the features. In the description of the present disclosure, “a plurality of” means two or more, unless expressly specified otherwise.

In the description of the present disclosure, it should be noted that unless otherwise explicitly specified and defined, the terms “mounted”, “connected” and “fixed” should be understood in a broad sense. For example, fixed connection, detachable connection or integral connection can be used. Mechanical connection or electrical connection can be used. Direct connection, indirect connection via an intermediate medium or interior communication of two elements can be used. For those of ordinary skill in the art, the specific meanings of the above terms in the present disclosure may be understood according to specific circumstances.

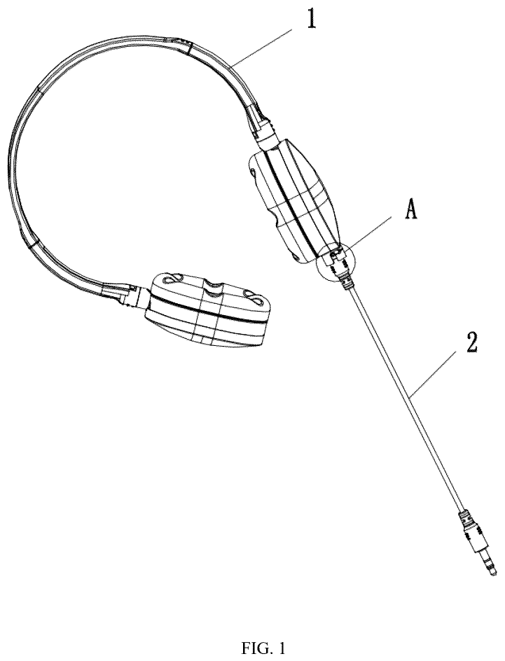

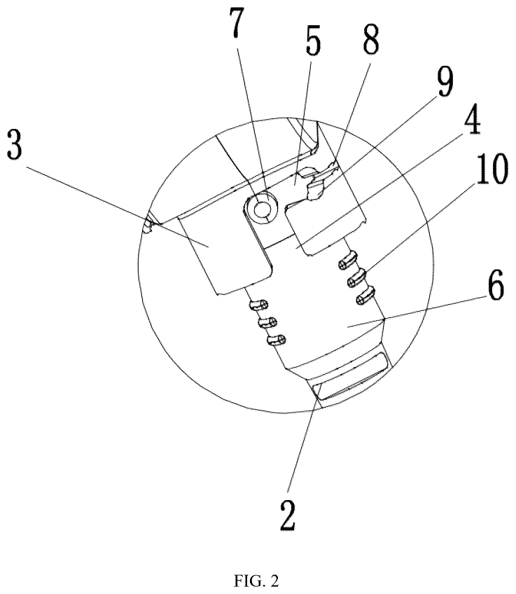

As shown in FIGS. 1 and 2, a headphone audio cable connection structure includes a headphone body 1 and an audio cable 2, where the headphone body 1 is provided with an audio cable insertion hole and a clamping sleeve 3, the audio cable extends into the clamping sleeve 3 and is inserted into the audio cable insertion hole, and the audio cable 2 is connected to the clamping sleeve 3 in a buckled manner. A buckle structure is added for connection, which ensures a stable connection of the audio cable and prevents the audio cable from falling off.

Inserting grooves 4 and clamping grooves 5 are formed on a side wall of the clamping sleeve 3, the inserting groove 4 extends along an axis direction of the clamping sleeve 3, the clamping groove 5 extends along a radial direction of the clamping sleeve 3, the clamping groove 5 is communicated with the inserting groove 4, the audio cable 2 is sleeved with a clamping seat 6, protruding clamping blocks 7 are arranged on the clamping seat 6, and the protruding clamping block 7 extends into the inserting groove 4 and then the clamping seat 6 rotates to move the protruding clamping block 7 into the clamping groove 5, so that the clamping seat 6 is securely fastened to the clamping sleeve 3. The inserting groove 4 is vertically arranged, the clamping groove 5 is horizontally arranged, and the protruding clamping block 7 extends into the inserting groove 4 without obstruction. After extending to a position of the clamping groove 5, the audio cable is rotated, so that the protruding clamping block 7 rotates together with the clamping seat 6, and movement into the clamping groove 5 from the position of the inserting groove is completed after rotation. In this case, the protruding clamping block 7 is limited by the side wall of the clamping groove 5, that is, it is limited in an axial direction of the clamping sleeve 3 and the audio cable 2 cannot be pulled outwards.

Crack grooves 8 are further formed on the clamping seat 6, and the crack groove 8 is communicated with the clamping groove 5. The crack groove 8 is capable of improving the elasticity and buffering effect of the clamping sleeve 3 at a position of grooving, and preventing the clamping sleeve 3 from being pulled and damaged.

The inserting groove 4 and the clamping groove 5 are distributed in a vertical direction, and the crack groove 8 and the clamping groove 5 are arranged in the same direction.

The side wall of the clamping sleeve 3 is symmetrically provided with two inserting grooves, two clamping grooves and two crack grooves, and the clamping seat is symmetrically provided with two protruding clamping blocks, which improves the stability and reliability of assembly.

The clamping groove 5 is provided with a groove position 9, and a portion of the protruding clamping block 7 extends into the groove position 9 after the protruding clamping block 7 moves into the clamping groove 5, to better accommodate the protruding clamping block 7, where the protruding clamping block 7 is cylindrical.

The protruding clamping blocks 7 are integrally formed on the clamping seat 6, and the side wall of the clamping seat 6 is provided with anti-slip fringes 10 to generate the anti-slip effect.

In the present disclosure, the clamping seat can be directly formed on the audio cable, and the clamping seat extends into the clamping sleeve. To successfully insert the protruding clamping block, the protruding clamping block needs to be aligned with the inserting groove. After the protruding clamping block is inserted into a designated position of the clamping groove, an insertion connection end of the audio cable has been inserted into the audio cable insertion hole of the headphone body. Rotating the audio cable drives the protruding clamping block to move into the clamping groove, so that the protruding clamping block is limited by the clamping groove, that is, the protruding clamping block is limited in the axis direction of the audio cable. Then buckle mounting is completed in a stable and reliable manner.

It should be noted that the above is only a preferred embodiment of the present disclosure, and is not intended to limit the present disclosure. Although the present disclosure has been described in detail with reference to the above embodiment, for those skilled in the art, it is still apparent that the technical solutions described in the above embodiment may be modified, or some technical features thereof may be equivalently replaced. Any modifications, equivalent replacements, improvements, etc. made within the spirit and principles of the present disclosure shall fall within the protection scope of the present disclosure.

What is claimed is:

1. A headphone audio cable connection structure, comprising a headphone body and an audio cable, wherein the headphone body is provided with an audio cable insertion hole and a clamping sleeve, the audio cable extends into the clamping sleeve and is inserted into the audio cable insertion hole, and the audio cable is connected to the clamping sleeve in a buckled manner.

2. The headphone audio cable connection structure according to claim 1, wherein inserting grooves and clamping grooves are formed on a side wall of the clamping sleeve, the inserting groove extends along an axis direction of the clamping sleeve, the clamping groove extends along a radial direction of the clamping sleeve, the clamping groove is communicated with the inserting groove, the audio cable is sleeved with a clamping seat, protruding clamping blocks are arranged on the clamping seat, and the protruding clamping block extends into the inserting groove and then the clamping seat rotates to move the protruding clamping block into the clamping groove, so that the clamping seat is securely fastened to the clamping sleeve.

3. The headphone audio cable connection structure according to claim 2, wherein crack grooves are further formed on the clamping seat, and the crack groove is communicated with the clamping groove.

4. The headphone audio cable connection structure according to claim 3, wherein the inserting groove and the clamping groove are distributed in a vertical direction, and the crack groove and the clamping groove are arranged in the same direction.

5. The headphone audio cable connection structure according to claim 2, wherein the side wall of the clamping sleeve is symmetrically provided with two inserting grooves, two clamping grooves and two crack grooves, and the clamping seat is symmetrically provided with two protruding clamping blocks.

6. The headphone audio cable connection structure according to claim 2, wherein the clamping groove is provided with a groove position, and a portion of the protruding clamping block extends into the groove position after the protruding clamping block moves into the clamping groove.

7. The headphone audio cable connection structure according to claim 2, wherein the protruding clamping block is cylindrical.

8. The headphone audio cable connection structure according to claim 2, wherein the protruding clamping blocks are integrally formed on the clamping seat.

9. The headphone audio cable connection structure according to claim 2, wherein the side wall of the clamping seat is provided with anti-slip fringes.
